(19) United States
(12) Patent Application Publication
(10) Pub. No.: US 2007/0211818 A1
(43) Pub. Date: Sep. 13, 2007

(54) Method and apparatus for bit-rate enhancement and wireless communication using the same

(75) Inventors: Hung-Cheng Chien, Taipei (TW); Szu-Wei Hou, Sinying City (TW); Yi-Chun Lu, Pingzhen City (TW)

Correspondence Address: BACON & THOMAS, PLLC, 625 SLATERS LANE, FOURTH FLOOR, ALEXANDRIA, VA, 22314, US

(73) Assignee: Uniband Electronic Corp., Hsinchu City (TW)

(21) Appl. No.: 11/714,786

(22) Filed: Mar. 7, 2007

Related U.S. Application Data
(60) Provisional application No. 60/779,453, filed on Mar. 7, 2006.

(51) Int. Cl. H04L 27/00

(52) U.S. Cl. 375/295; 375/316

(57) ABSTRACT

A method and an apparatus for bit-rate enhancement and a wireless communication system using the same are disclosed. According to the present invention, two approaches are provided for bit-rate enhancement: one is an increase of chip-rate and the other is a decrease of chip number associated with on symbol. As such, the transmission bit-rate can be enhanced significantly so as to facilitate the applications of wireless voice communications or security.

### CROSS-REFERENCE TO RELATED APPLICATION

The present application claims the priority benefits of U.S. provisional application entitled “Method and Apparatus for Bit-Rate Enhancement and Wireless Voice Communication Using the Same” filed on Mar. 7, 2006 Ser. No. 60/779,453. All disclosures of this application are incorporated herein by reference.

### BACKGROUND OF THE INVENTION

1. Field of the Invention

The present invention generally relates to spread spectrum communications. More particular, the present invention relates to a method and an apparatus for bit-rate enhancement and a wireless communication system using the same.

2. Description of Related Arts

Spread spectrum communication systems spread transmitted signals over bandwidths much greater than those actually required to transmit the information. The spreading spectrum technologies have been widely used both in military and commercial wireless communication systems, and applications based on the emerging IEEE 802.15.4 standard. There are many advantages of using spread spectrum approach, and the most important ones are: (1) due to spreading gain, spread spectrum systems are very robust with respect to noise and interferences; (2) multipath fading has a much less impact to spread spectrum systems; and (3) spread spectrum systems are inherently secure.

IEEE 802.15.4 standard utilizes spread spectrum technology that spreading codes are constructed to have good auto-correlation and cross-correlation properties. As such, one code can effectively differentiate itself from the other codes under noisy conditions. The ideal spreading codes are orthogonal, which means the cross-correlation between two different codes is zero. In IEEE 802.15.4 standard, the transmitted data stream is grouped into one or several bits as one symbol and mapped and spreaded, i.e., encoded into M-ary Pseudo Noise (PN) spreading codes or so-called “chips.” While operating at 2.4 GHz frequency band, 4-bit data, which are group to be one symbol, are converted into 32 chips in I-channel and Q-channel alternately in transmitter side. A mapping table of symbol-to-chip at 2.4 GHz is provided in FIG. 1. While operating at 868/915 MHz, one bit data, which is grouped to be one symbol, is converted into 15 chips I-channel and Q-channel alternately in transmitter side. a mapping table of symbol-to-chip at 868/915 MHz is provided in FIG. 2. In IEEE 802.15.4 standard, half-sine pulse waveform is utilized for chip transmission at 2.4 GHz and raised-cosine pulse waveform is utilized for chip transmission at 868/915 MHz.

A diagram of half-sine pulse waveform is shown in FIG. 3 as an example. In FIG. 3, the left half-sine pulse represents the chip with logic “one” and the right half-sine pulse designates the chip with logic “zero.” Each chip is provided with a period of 1 μsec when the IEEE 802.15.4-based system is operated at a bit-rate of 250 Kbps associated with a chip rate of 1M chips per second. In the corresponding receiver side, the received chips are sampled at a clock rate of, for example, 20 MHz to as to generate 20 samples per chip as shown in FIG. 2.

### SUMMARY OF THE INVENTION

Therefore, it is an object of the present invention to provide a method and an apparatus for bit-rate enhancement and a wireless communication system using the same such that data stream can be processed at higher rate.

For achieving the above-identified object, the present invention provides a method of bit-rate enhancement in the application of a wireless communication system, the method comprising the following steps of: converting bit data to symbol data; converting the symbol date to a plurality of chips, wherein each of the plurality of chips has a period less than 1 μsec; and modulating the plurality of chips to a radio frequency signal for output.

The present invention provides a method of bit-rate enhancement in the application of a wireless communication system, the method comprising the steps of:

receiving a radio frequency signal; demodulating the radio frequency signal to a plurality of chips, wherein each of the plurality of chips has a period less than 1 μsec; converting the plurality of chips to symbol data; and converting the symbol data to bit data.

The present invention provides a method of bit-rate enhancement in the application of a wireless communication system, the method comprising the following steps of: converting bit data to symbol data; converting the symbol data to N chips, wherein N is less than 32 at a first bandwidth and less than 15 at a second bandwidth; and modulating the plurality of chips to a radio frequency signal.

The present invention provides a method of bit-rate enhancement in the application of a wireless communication system, the method comprising the following steps of: receiving a radio frequency signal; demodulating the radio frequency signal to N chips, wherein N is less than 32 at a first bandwidth and less than 15 at a second bandwidth; converting the N chips to symbol data; and converting the symbol data to bit data.

The present invention provides an apparatus of bit-rate enhancement in a wireless communication system, the apparatus comprising: means for converting bit data to symbol data; means for converting the symbol date to a plurality of chips, wherein each of the plurality of chips has a period less than 1 μsec; and means for modulating the plurality of chips to a radio frequency signal for output.

The present invention provides an apparatus of bit-rate enhancement in a wireless communication system, the apparatus comprising: means for receiving a radio frequency signal; means for demodulating the radio frequency signal to a plurality of chips, wherein each of the plurality of chips has a period less than 1 μsec; means for converting the plurality of chips to symbol data; and means for converting the symbol data to bit data.

The present invention provides an apparatus of bit-rate enhancement in a wireless communication system, the apparatus comprising: means for converting bit data to symbol data; means for converting the symbol data to N chips, wherein N is less than 32 at a first bandwidth and less than 15 at a second bandwidth; and means for modulating the plurality of chips to a radio frequency signal.

The present invention provides an apparatus of bit-rate enhancement in a wireless communication system, the apparatus comprising: means for receiving a radio frequency signal; means for demodulating the radio frequency signal to N chips, wherein N is less than 32 at a first bandwidth and less than 15 at a second bandwidth; means for converting the N chips to symbol data; and means for converting the symbol data to bit data.

The present invention provides a wireless communication system of bit-rate enhancement, comprising: in a transmitter comprising: means for converting bit data to symbol data; means for converting the symbol date to a plurality of chips, wherein each of the plurality of chips has a period less than μsec; and means for modulating the plurality of chips to a radio frequency signal for output; in a receiver comprising: means for receiving the radio frequency signal; means for demodulating the radio frequency signal to a plurality of received chips, wherein each of the plurality of received chips has a period less than 1 μsec; means for converting the plurality of received chips to received symbol data; and means for converting the received symbol data to received bit data.

The present invention provides a wireless communication system of bit-rate enhancement, comprising: in a transmitter, comprising: means for converting bit data to symbol data; means for converting the symbol data to N chips, wherein N is less than 32 at a first bandwidth and less than 15 at a second bandwidth; and means for modulating the plurality of chips to a radio frequency signal; in a receiver, comprising: means for receiving the radio frequency signal; means for demodulating the radio frequency signal to N received chips, wherein N is less than 32 at a first bandwidth and less than 15 at a second bandwidth; means for converting the N received chips to received symbol data; and means for converting the received symbol data to received bit data.

### BRIEF DESCRIPTION OF THE DRAWINGS

FIG. 1 is a mapping table of conventional symbol-to-chip at 2.4 GHz bandwidth;

FIG. 2 is a mapping table of conventional symbol-to-chip at 868/915 MHz bandwidth;

FIG. 3 is an exemplary diagram of half-sine pulse waveform;

FIG. 4 is a diagram to explain conventional sampling approach;

FIG. 5 schematically depicts a block diagram of a bit-rate enhancement apparatus in transmitter side in accordance with one preferred embodiment of the present invention;

FIG. 6 is a schematic diagram of comparing the half-sine waveforms according to the conventional approach and the present invention;

FIG. 7 schematically depicts a block diagram of a bit-rate enhancement apparatus in receiver side in accordance with one preferred embodiment of the present invention;

FIG. 8 is a schematic diagram of comparing the half-sine sampling according to the conventional approach and the present invention;

FIG. 9 schematically depicts a block diagram of a bit-rate enhancement apparatus in transmitter side in accordance with another preferred embodiment of the present invention;

FIG. 10 schematically depicts a block diagram of a bit-rate enhancement apparatus in receiver side in accordance with another preferred embodiment of the present invention;

FIG. 11 is a mapping table of symbol-to-chip at 2.4 GHz bandwidth in accordance with another preferred embodiment; and

FIG. 12 is a mapping table of symbol-to-chip at 868/915 MHz bandwidth in accordance with another preferred embodiment.

### DETAILED DESCRIPTION OF THE PREFERRED EMBODIMENTS

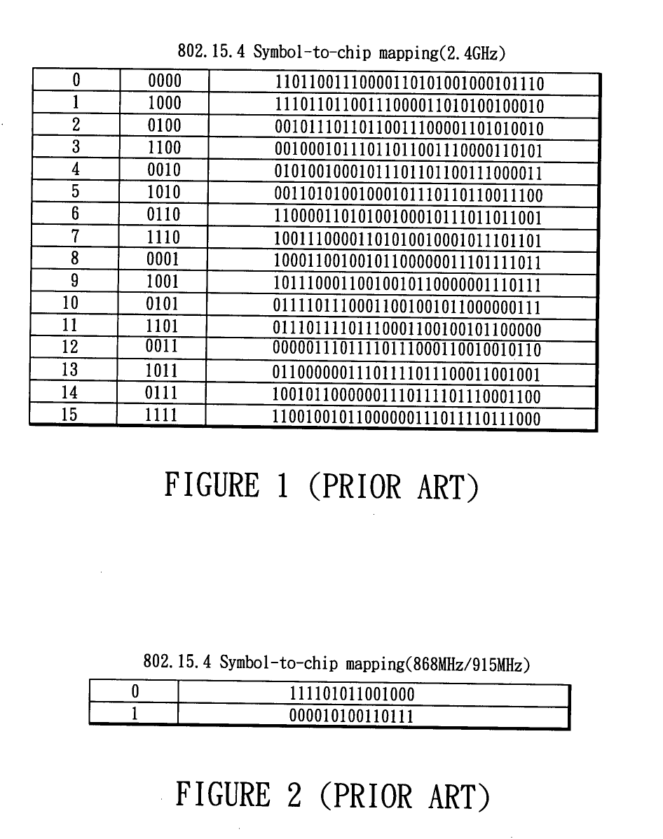

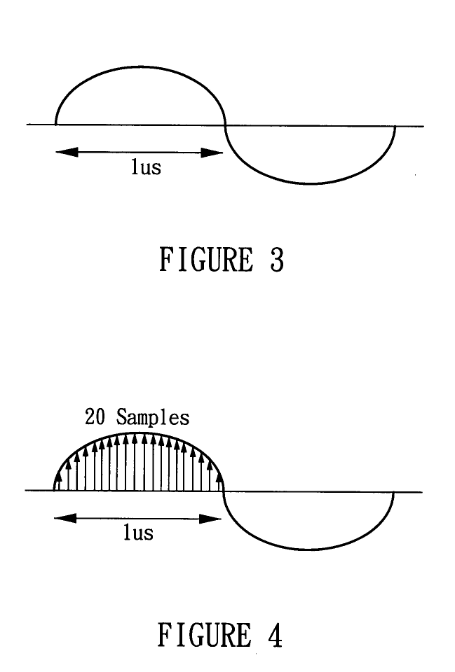

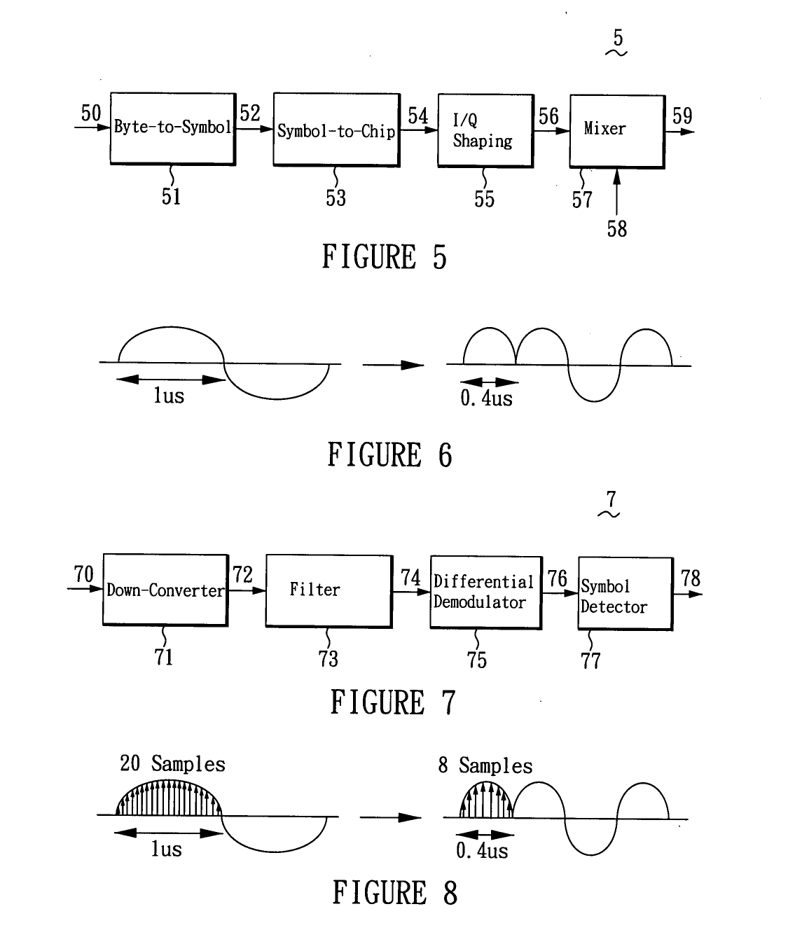

Referring to FIG. 5, a block diagram of a bit-rate enhancement apparatus in transmitter side in accordance with one preferred embodiment of the present invention is illustrated schematically. In FIG. 5, a transmitter 5 includes a byte-to-symbol converter 51, a symbol-to-chip converter 53, a I/Q shaper 55 and a mixer 57. The byte-to-symbol converter 51 is employed to convert bit data 50 into symbol data 52. The symbol-to-chip converter 53 is used to convert the symbol data 52 into chips 54. An example of symbol-to-chip mapping is shown in FIGS. 1 and 2. The I/Q shaper 55 is utilized to shape waveform of the chips 54 in I-channel and Q-channel to generate a baseband signal 56. The baseband signal 56 is mixed with a carrier 58 at the mixer such that the baseband signal 56 is modulated to become a radio frequency signal for transmission over the air. When the transmitter 5 is operated at 2.4 GHz, the carrier 58 has a frequency of 2.4 GHz. When the transmitter is operated at 868/915 MHz, the carrier 58 has a frequency of 868/915 MHz.

In this embodiment, the transmission bit-rate can be increased by means of chip-rate enhancement. As shown in FIG. 5, after the symbol data 52 are converted by the symbol-to-chip converter 53 into the corresponding chips 54, the chip-rate thereof is increased greater than 1 MHz and the chip period is decreased less than μsec as well. By taking 2.4 GHz bandwidth and the chips 54 are transmitted in half-sine pulse waveform as an example, the period of each chip 54 is decreased to 0.4 μsec and thus the corresponding chip-rate is increased to 2.5 MHz. The waveform of the baseband signals 56 after processing of the I/Q shaper 55 is shown in the right-hand side of FIG. 6 where the conventional waveform is shown in left-hand side of FIG. 6.

Referring to FIG. 7, a block diagram of a bit-rate enhancement apparatus in receiver side in accordance with one preferred embodiment of the present invention is depicted schematically. In FIG. 7, a receiver 7 includes a down-converter 71, a filter 73, a differential demodulator 75 and a symbol detector 77. The down-converter 71 is employed to receive a radio frequency signal 70 and convert the received radio frequency signal 70 into a baseband signal 72. The down-converter 71 includes the converter for converting the radio frequency signals into intermediate frequency signals and the converter for converting the intermediate frequency signals into baseband signals. The filter 73 is used to convert the baseband signal 72 into the corresponding chips 74. If half-sine pulse waveform is applied, the filter 73 is a half-sine shaping filter as an example. Because the chip-rate of the received data has been increased significantly, the filter coefficients should be modified to allow the passage of signals with broader bandwidth. Thereafter, the differential demodulator 75 is used to convert the received chips 74 into symbol data 76. The differential demodulator 75 is used to generate a sequence of phase differences which QPSK, O-QPSK and M-ary PSk can be applied. Then, the symbol date 76 are converted by the symbol detector 77 into bit data for further processing.

In this embodiment, the transmission bit-rate has been increased by means of chip-rate enhancement. As shown in FIG. 7, the coefficients of the filter 73 should be modified to accommodate the reception of bit-rate-enhanced radio frequency signal 70. According to the present invention, the chips 74 generated by the filter 73 have a chip-rate greater than 1 MHz which means chip period less than 1 μsec. By taking 2.4 GHz bandwidth and the chips 74 are transmitted in half-sine pulse waveform as an example, the period of each chip 74 is decreased to 0.4 μsec and thus the corresponding chip-rate is increased to 2.5 MHz. If the differential demodulator 75 samples the chips at a sampling clock of 20 MHz, the number of samples is decrease to 8 as shown in the right-hand side of FIG. 8 where the conventional sampled waveform is shown in left-hand side of FIG. 8.

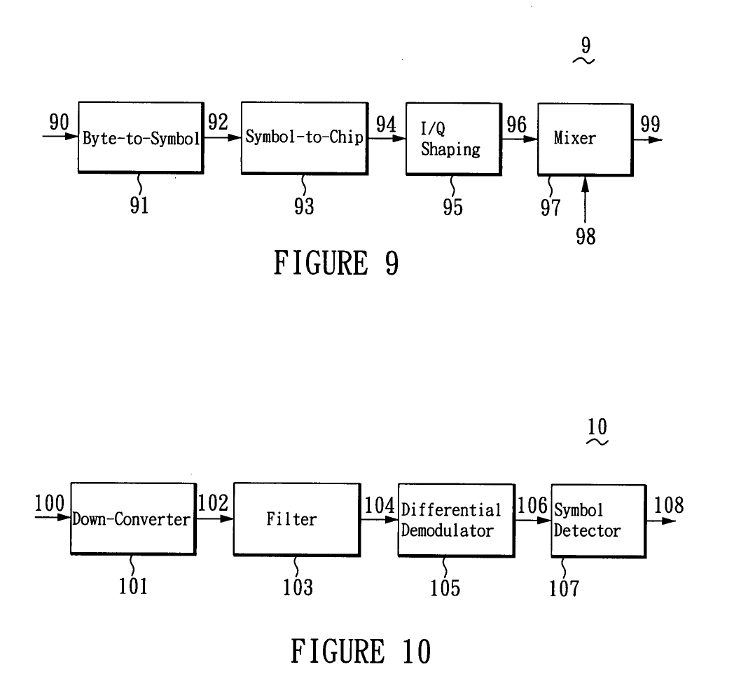

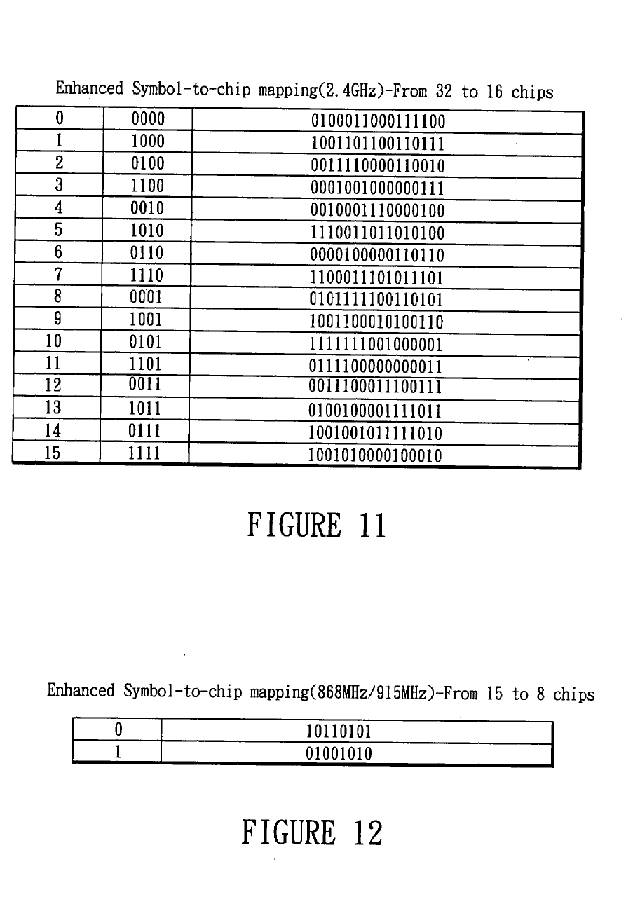

Referring to FIG. 9, a block diagram of a bit-rate enhancement apparatus in transmitter side in accordance with another preferred embodiment of the present invention is depicted schematically. In FIG. 9, a transmitter 9 includes a byte-to-symbol converter 91, a symbol-to-chip converter 93, a I/Q shaper 95 and a mixer 97. The byte-to-symbol converter 91 is employed to convert bit data 90 into symbol data 92. The symbol-to-chip converter 93 is used to convert the symbol data 92 into chips 94. An example of symbol-to-chip mapping is shown in FIGS. 11 and 12. The I/Q shaper 95 is utilized to shape waveform of the chips 94 in I-channel and Q-channel to generate a baseband signal 96. The baseband signal 96 is mixed with a carrier 98 at the mixer such that the baseband signal 96 is modulated to become a radio frequency signal for transmission over the air. When the transmitter 9 is operated at 2.4 GHz, the carrier 98 has a frequency of 2.4 GHz. When the transmitter is operated at 868/915 MHz, the carrier 98 has a frequency of 868/915 MHz.

In this embodiment, the transmission bit-rate can be enhanced by means of decreasing the chip number of symbol-to-chip mapping. As shown in FIG. 9, after the symbol 92 is converted by the symbol-to-chip converter 93 into the chips 94, the chip number of symbol-to-chip mapping is less than that of the conventional approach. At 2.4 GHz bandwidth, the chip number of chips 94 associated with each symbol 92 is decrease from 32 to 16, for example, as shown in the mapping table of FIG. 11. At 868/915 MHz bandwidth, the chip number of chips 94 associated with each symbol 92 is decrease from 15 to 8, for example, as shown in the mapping table of FIG. 12. Therefore, the symbol-to-chip converter 93 is employed to convert the symbol 92 into the corresponding chips 94 based upon the corresponding relation of symbol-to-chip mapping. The mapping relationships as shown in FIGS. 11 and 12 are ones of many feasible examples.

Referring to FIG. 10, a block diagram of a bit-rate enhancement apparatus in receiver side in accordance with one preferred embodiment of the present invention is depicted schematically. In FIG. 10, a receiver 10 includes a down-converter 101, a filter 103, a differential demodulator 105 and a symbol detector 107. The down-converter 101 is employed to receive a radio frequency signal 100 and convert the received radio frequency signal 100 into a baseband signal 102. The down-converter 101 includes the converter for converting the radio frequency signals into intermediate frequency signals and the converter for converting the intermediate frequency signals into baseband signals. The filter 103 is used to convert the baseband signal 102 into the corresponding chips 104. If half-sine pulse waveform is applied, the filter 103 is a half-sine shaping filter as an example. Because the chip-rate of the received data has been increased significantly, the filter coefficients should be modified to allow the passage of signals with broader bandwidth. Thereafter, the differential demodulator 105 is used to convert the received chips 104 into symbol data 106. The differential demodulator 105 is used to generate a sequence of phase differences which QPSK, O-QPSK and M-ary PSk can be applied. Then, the symbol date 106 is converted by the symbol detector 107 into bit data for further processing.

In this embodiment, the transmission bit-rate can be enhanced by means of decreasing the chip number of symbol-to-chip mapping. As shown in FIG. 10, the chip number, associated with one symbol, of the received chips 104 is less than that of the conventional approach. Therefore, the symbol detector 107 is employed to convert the chips 104 into the corresponding symbol 106 based upon the corresponding relation of symbol-to-chip mapping. The mapping relationships as shown in FIGS. 11 and 12 are ones of many feasible examples.

Although the description above contains much specificity, it should not be construed as limiting the scope of the invention but as merely providing illustrations of some of the presently preferred embodiments of the present invention. Thus, the scope of the present invention should be determined by the appended claims and their equivalents, rather than by the examples given.

What is claimed is:

1. A method of bit-rate enhancement in the application of a wireless communication system, said method comprising the following steps of:
converting bit data to symbol data;
converting said symbol date to a plurality of chips, wherein each of said plurality of chips has a period less than 1 μsec; and
modulating said plurality of chips to a radio frequency signal for output.

2. The method as claimed in claim 1, further comprising a step of mixing said plurality of chips with a carrier to generate said radio frequency signal.

3. The method as claimed in claim 2, wherein said carrier has a frequency of 2.4 GHz.

4. The method as claimed in claim 3, wherein each of said plurality of chips has a half-sine waveform.

5. The method as claimed in claim 2, wherein said carrier has a frequency of 868/915 MHz.

6. The method as claimed in claim 5, wherein each of said plurality of chips has a raised-cosine waveform.

7. A method of bit-rate enhancement in the application of a wireless communication system, said method comprising the steps of:
receiving a radio frequency signal;
demodulating said radio frequency signal to a plurality of chips, wherein each of said plurality of chips has a period less than 1 μsec;
converting said plurality of chips to symbol data; and
converting said symbol data to bit data.

8. The method as claimed in claim 7, wherein said radio frequency signal includes a carrier having a frequency of 2.4 GHz.

9. The method as claimed in claim 8, wherein each of said plurality of chips has a half-sine waveform.

10. The method as claimed in claim 7, wherein said radio frequency signal includes a carrier having a frequency of 868/915 MHz.

11. The method as claimed in claim 10, wherein each of said plurality of chips has a raised-cosine waveform.

12. A method of bit-rate enhancement in the application of a wireless communication system, said method comprising the following steps of:
converting bit data to symbol data;
converting said symbol data to N chips, wherein N is less than 32 at a first bandwidth and less than 15 at a second bandwidth; and
modulating said plurality of chips to a radio frequency signal.

13. The method as claimed in claim 12, further comprising a step of mixing said plurality of chips with a carrier to generate said radio frequency signal.

14. The method as claimed in claim 13, wherein said first bandwidth and said carrier have a frequency of 2.4 GHz.

15. The method as claimed in claim 14, wherein each of said N chips has a half-sine waveform.

16. The method as claimed in claim 13, wherein said second bandwidth and said carrier have a frequency of 868/915 MHz.

17. The method as claimed in claim 16, wherein each of said N chips has a raised-cosine waveform.

18. A method of bit-rate enhancement in the application of a wireless communication system, said method comprising the following steps of:
receiving a radio frequency signal;
demodulating said radio frequency signal to N chips, wherein N is less than 32 at a first bandwidth and less than 15 at a second bandwidth;
converting said N chips to symbol data; and
converting said symbol data to bit data.

19. The method as claimed in claim 18, wherein said first bandwidth and a carrier of said radio frequency signal have a frequency of 2.4 GHz.

20. The method as claimed in claim 19, wherein each of said N chips has a half-sine waveform.

21. The method as claimed in claim 18, wherein said second bandwidth and a carrier of said radio frequency signal have a frequency of 868/915 MHz.

22. The method as claimed in claim 21, wherein each of said N chips has a raised-cosine waveform.

23. An apparatus of bit-rate enhancement in a wireless communication system, the apparatus comprising:
means for converting bit data to symbol data;
means for converting said symbol date to a plurality of chips, wherein each of said plurality of chips has a period less than 1 μsec; and
means for modulating said plurality of chips to a radio frequency signal for output.

24. The apparatus as claimed in claim 23, further comprising means for mixing said plurality of chips with a carrier to generate said radio frequency signal.

25. The apparatus as claimed in claim 24, wherein said carrier has a frequency of 2.4 GHz.

26. The apparatus as claimed in claim 25, wherein each of said plurality of chips has a half-sine waveform.

27. The apparatus as claimed in claim 24, wherein said carrier has a frequency of 868/915 MHz.

28. The apparatus as claimed in claim 27, wherein each of said plurality of chips has a raised-cosine waveform.

29. An apparatus of bit-rate enhancement in a wireless communication system, the apparatus comprising:
means for receiving a radio frequency signal;
means for demodulating said radio frequency signal to a plurality of chips, wherein each of said plurality of chips has a period less than 1 μsec;
means for converting said plurality of chips to symbol data; and
means for converting said symbol data to bit data.

30. The apparatus as claimed in claim 29, wherein said radio frequency signal includes a carrier having a frequency of 2.4 GHz.

31. The apparatus as claimed in claim 30, wherein each of said plurality of chips has a half-sine waveform.

32. The apparatus as claimed in claim 29, wherein said radio frequency signal includes a carrier having a frequency of 868/915 MHz.

33. The apparatus as claimed in claim 32, wherein each of said plurality of chips has a raised-cosine waveform.

34. An apparatus of bit-rate enhancement in a wireless communication system, the apparatus comprising:
means for converting bit data to symbol data;
means for converting said symbol data to N chips, wherein N is less than 32 at a first bandwidth and less than 15 at a second bandwidth; and
means for modulating said plurality of chips to a radio frequency signal.

35. The apparatus as claimed in claim 34, further comprising a step of mixing said plurality of chips with a carrier to generate said radio frequency signal.

36. The apparatus as claimed in claim 35, wherein said first bandwidth and said carrier have a frequency of 2.4 GHz.

37. The apparatus as claimed in claim 36, wherein each of said N chips has a half-sine waveform.

38. The apparatus as claimed in claim 35, wherein said second bandwidth and said carrier have a frequency of 868/915 MHz.

39. The apparatus as claimed in claim 38, wherein each of said N chips has a raised-cosine waveform.

40. An apparatus of bit-rate enhancement in a wireless communication system, the apparatus comprising:
means for receiving a radio frequency signal;
means for demodulating said radio frequency signal to N chips, wherein N is less than 32 at a first bandwidth and less than 15 at a second bandwidth;
means for converting said N chips to symbol data; and
means for converting said symbol data to bit data.

41. The apparatus as claimed in claim 40, wherein said first bandwidth and a carrier of said radio frequency signal have a frequency of 2.4 GHz.

42. The apparatus as claimed in claim 41, wherein each of said N chips has a half-sine waveform.

43. The apparatus as claimed in claim 40, wherein said second bandwidth and a carrier of said radio frequency signal have a frequency of 868/915 MHz.

44. The apparatus as claimed in claim 43, wherein each of said N chips has a raised-cosine waveform.

45. A wireless communication system of bit-rate enhancement, comprising:
in a transmitter comprising:
means for converting bit data to symbol data;
means for converting said symbol date to a plurality of chips, wherein each of said plurality of chips has a period less than 1 μsec; and
means for modulating said plurality of chips to a radio frequency signal for output;
in a receiver comprising:
means for receiving said radio frequency signal;
means for demodulating said radio frequency signal to a plurality of received chips, wherein each of said plurality of received chips has a period less than 1 μsec;
means for converting said plurality of received chips to received symbol data; and
means for converting said received symbol data to received bit data.

46. The apparatus as claimed in claim 45, further comprising means for mixing said plurality of chips with a carrier to generate said radio frequency signal.

47. The apparatus as claimed in claim 46, wherein said carrier has a frequency of 2.4 GHz.

48. The apparatus as claimed in claim 47, wherein each of said plurality of chips has a half-sine waveform.

49. The apparatus as claimed in claim 46, wherein said carrier has a frequency of 868/915 MHz.

50. The apparatus as claimed in claim 49, wherein each of said plurality of chips has a raised-cosine waveform.

51. A wireless communication system of bit-rate enhancement, comprising:
in a transmitter, comprising:
means for converting bit data to symbol data;
means for converting said symbol data to N chips, wherein N is less than 32 at a first bandwidth and less than 15 at a second bandwidth; and
means for modulating said plurality of chips to a radio frequency signal;
in a receiver, comprising:
means for receiving said radio frequency signal;
means for demodulating said radio frequency signal to N received chips, wherein N is less than 32 at a first bandwidth and less than 15 at a second bandwidth;
means for converting said N received chips to received symbol data; and
means for converting said received symbol data to received bit data.

52. The system as claimed in claim 51, further comprising means for mixing said N chips with a carrier to generate said radio frequency signal.

53. The apparatus as claimed in claim 52, wherein said first bandwidth and said carrier have a frequency of 2.4 GHz.

54. The apparatus as claimed in claim 53, wherein each of said N chips has a half-sine waveform.

55. The apparatus as claimed in claim 52, wherein said second bandwidth and said carrier have a frequency of 868/915 MHz.

56. The apparatus as claimed in claim 55, wherein each of said N chips has a raised-cosine waveform.
